(19) United States
(12) Patent Application Publication
(10) Pub. No.: US 2026/0181036 A1
(43) Pub. Date: Jun. 25, 2026

(54) DISASTER RECOVERY PROCESSING METHOD AND APPARATUS FOR CDN LIVE STREAMING, DEVICE, AND MEDIUM

(71) Applicant: BEIJING BAIDU NETCOM SCIENCE TECHNOLOGY CO., LTD., Beijing (CN)

(72) Inventors: Jinxin MAO, Beijing (CN); Chenfei WANG, Beijing (CN); Tengfei SHAN, Beijing (CN)

(73) Assignee: BEIJING BAIDU NETCOM SCIENCE TECHNOLOGY CO., LTD., Beijing (CN)

(21) Appl. No.: 19/085,188

(22) Filed: Mar. 20, 2025

(30) Foreign Application Priority Data
Dec. 20, 2024 (CN) 202411899339.X

(51) Int. Cl. H04L 65/80; H04L 41/0654; H04L 41/16; H04L 65/61

(52) U.S. Cl. CPC H04L 65/80; H04L 41/0654; H04L 41/16; H04L 65/61

(57) ABSTRACT

The present disclosure provides a disaster recovery processing method and a disaster recovery processing apparatus for CDN live streaming, a device, and a medium, which relates to the field of cloud computing technologies, and in particular, to CDN (content delivery network) live streaming field. A specific implementation is: a streaming quality analysis platform acquires quality data of an edge node and a central node from a system log, and determines a fault node and a fault type thereof using a fault identification model or threshold ranges of the quality data. The identified fault node information is sent to a node configuration platform, to generate configuration blocks including filters and processing. The configuration blocks are issued to respective nodes. The node determines, based on streaming information, whether a filter is hit, and performs a corresponding disaster recovery processing when it is hit.

### CROSS-REFERENCE TO RELATED APPLICATIONS

The present application claims priority to Chinese Patent Application No. 202411899339.X, filed on Dec. 20, 2024, which is hereby incorporated by reference in its entirety.

### TECHNICAL FIELD

The present disclosure relates to CDN (content delivery network) live streaming field in the field of cloud computing technologies, and in particular, to a disaster recovery processing method and a disaster recovery processing apparatus for CDN live streaming, a device, and a medium.

### BACKGROUND

With rapid development of Internet technologies and continuous increase of demands for video content, a content delivery network (CDN) is widely applied all over the world. By deploying server nodes at a plurality of geographical locations, the CDN can effectively improve transmission speed and reliability of the content. Especially in live streaming service, the role of CDN is especially important.

For the live streaming service, the video content needs to be real-time and efficiently transmitted to viewers from all over the world, which impose higher requirements on performance and stability of the CDN. In order to ensure continuity and high-quality transmission of the live streaming service, a CDN system needs to have a powerful disaster recovery capability.

### SUMMARY

The present disclosure provides a disaster recovery processing method and a disaster recovery processing apparatus for CDN live streaming, a device, and a medium.

According to a first aspect of the present disclosure, a disaster recovery processing method for CDN live streaming is provided, including:
acquiring quality data of a node from an acquired log;
determining, based on the quality data, at least one fault node and a fault type of each fault node;
sending the at least one fault node and the fault type of each fault node to a node configuration platform, where the fault type of the at least one fault node is used for configuring the node to perform disaster recovery processing.

According to a second aspect of the present disclosure, a disaster recovery processing method for CDN live streaming is provided, including:
acquiring at least one fault node and a fault type of each fault node;
generating, based on the at least one fault node and the fault type of each fault node, a plurality of configuration blocks, where each configuration block comprises a filter and a corresponding processing operation;
issuing the plurality of configuration blocks, so as to enable respective nodes to perform disaster recovery processing based on the plurality of configuration blocks.

According to a third aspect of the present disclosure, provided is a disaster recovery processing method for CDN live streaming, including:
acquiring a plurality of configuration blocks, where the plurality of configuration blocks are obtained based on configuration of a fault node and a fault type, and each configuration block comprises a filter and a corresponding processing operation;
determining, based on the plurality of configuration blocks and streaming information of the node, whether a filter in any one of the configuration blocks is hit; and
when it is determined that a filter of a target configuration block is hit, performing disaster recovery processing according to a processing operation in the target configuration block.

According to a fourth aspect of the present disclosure, an electronic device is provided, including: a memory and a processor. The memory is stored with computer executable instructions. The processor executes the computer executable instructions stored in the memory, which enables the processor to execute the method according to the first to the third aspects.

According to a fifth aspect of the present disclosure, a non-transitory computer-readable storage medium storing computer instructions is provided, where the computer instructions are used for enabling a computer to execute the method according to the first to the third aspects.

It should be understood that, the content described in this section is not intended to identify key or critical features of the embodiments of the present disclosure, nor is it intended to limit the scope of the present disclosure. Other features of the present disclosure will be easily understood from the following description.

### BRIEF DESCRIPTION OF DRAWINGS

The accompanying drawings are used for better understanding of the solution, which are not intended to limit the present disclosure.

FIG. 1 is a scenario diagram of implementing a disaster recovery processing method for CDN live streaming of an embodiment of the present disclosure.

FIG. 2 is a schematic flowchart of a disaster recovery processing method for CDN live streaming provided by a first embodiment of the present disclosure.

FIG. 3(a) is a schematic diagram of a specific implementation of a disaster recovery processing method for CDN live streaming provided by a second embodiment of the present disclosure.

FIG. 3(b) is a schematic diagram of another specific implementation of a disaster recovery processing method for CDN live streaming provided by a second embodiment of the present disclosure.

FIG. 4 is a schematic diagram of a specific implementation of a disaster recovery processing method for CDN live streaming provided by a third embodiment of the present disclosure.

FIG. 5 is a schematic structural diagram of a disaster recovery processing apparatus for CDN live streaming provided by a first embodiment of the present disclosure.

FIG. 6 is a schematic structural diagram of a disaster recovery processing apparatus for CDN live streaming provided by a second embodiment of the present disclosure.

FIG. 7 is a schematic structural diagram of a disaster recovery processing apparatus for CDN live streaming provided by a third embodiment of the present disclosure.

FIG. 8 is a schematic structural diagram of an electronic device for implementing a disaster recovery processing method for CDN live streaming according to an embodiment of the present disclosure.

### DESCRIPTION OF EMBODIMENTS

Exemplary embodiments of the present disclosure will be described below with reference to accompanying drawings, in which various details of the embodiments of the present disclosure are included to facilitate understanding, and should be considered as merely exemplary. Accordingly, an ordinary person skilled in the art should recognize that various variations and modifications of the embodiments described herein can be made without departing from the scope and spirit of the present disclosure. Also, description of well-known functions and structures are omitted in the following description for clarity and conciseness.

Before describing the embodiments of the present disclosure, application background of the embodiments of the present disclosure will be explained first.

With popularization of the Internet and proliferation of consumption on video content, live streaming service has become an important part of modern digital media. The CDN plays a key role in the live streaming service. By deploying distributed nodes in a global range, the video content is effectively and quickly transmitted to viewers, thereby ensuring smooth viewing experience. However, the live streaming service has very high requirements on stability and real-time performance of the network. Any node fault or network abnormality may cause service interruption or quality degradation. Therefore, it is an important direction of current technology development to improve disaster recovery capability of a CDN system, and ensure that normal service can be quickly restored when a fault occurs.

In an application scenario of CDN live streaming, according to an existing disaster recovery processing method, generally, a fault node (i.e., a down node) is removed from a scheduling system. For a newly established live streaming connection, the method can indeed effectively avoid a node having a problem, and ensure high-quality transmission of a newly added live stream. However, in view of persistent connection characteristic of the live streaming services, service quality of a persistent connection that already exists (existing connection) is still affected. In addition, in the existing disaster recovery processing method, manual intervention is usually required to identify and process the fault node. An unnecessary delay exists between fault detection and traffic switching, thereby reducing a response speed of the system. Not only labor cost is increased, but also a newly established incremental data stream may be affected in a configuration and issuing process, resulting in degraded user experience.

In view of the above, it is a technical problem to be solved urgently to provide a technical solution that can implement true automated disaster recovery and fully meet the requirements of modern live streaming service for high reliability and high availability.

Based on the described technical problem, in a process of researching the automated disaster recovery processing method for CDN live streaming, the inventor found that by automatically transmitting the detected fault information to a node configuration platform, configuration blocks including specific filter rules and processing operations for different fault types can be generated, and can be promptly issued to respective nodes when a fault occurs. After receiving the configuration, the nodes determine, according to their streaming information, whether a filter in the configuration blocks is hit, and when the filter is hit, a corresponding processing operation is executed. Thus, automated disaster recovery is achieved. By means of the aforementioned method, not only the response speed of the system is improved, dependency on manual intervention is reduced, but also continuity and stability of the live streaming service is ensured, thereby significantly improving user experience.

Based on the above, the present disclosure provides a disaster recovery processing method and a disaster recovery processing apparatus for CDN live streaming, a device and a medium, which are applied to CDN (content delivery network) live streaming field in the technical field of cloud computing, so as to achieve technical effects of ensuring the continuity and stability of the live streaming service and improving the user experience.

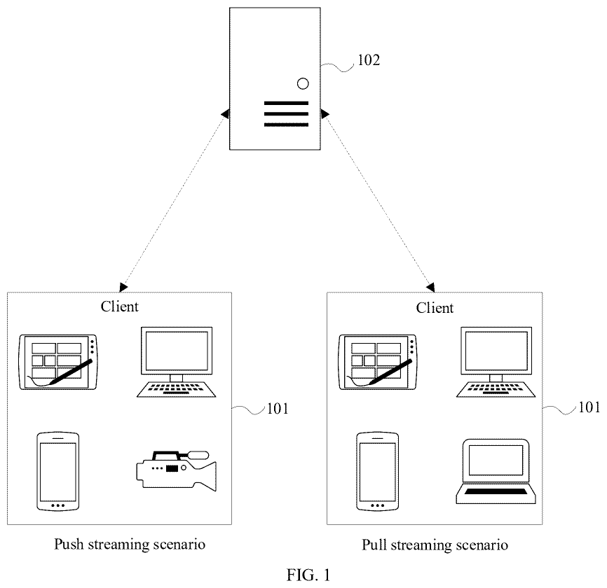

FIG. 1 is a scenario diagram of implementing a disaster recovery processing method for CDN live streaming of an embodiment of the present disclosure. The scenario at least includes a client 101, a server 102, etc. The CDN is deployed on the server 102. In a push-streaming scenario, a user uploads a live streaming content to an edge node of the CDN through the client 101. The edge node receives the content, and transmits it to a central node or other relay nodes, so as to be further distributed to other users. If a fault occurs at the edge node or the central node, it can be switched to other normal nodes quickly to ensure that the live streaming is not interrupted. In a pull-streaming scenario, the user requests to receive the live streaming content from the edge node of the CDN through the client 101, and the edge node obtains the content from the central node and transmits it to a viewer. If a fault occurs at the edge node or the central node, it may be switched to other normal nodes quickly, so as to ensure that reception of the live streaming content is not interrupted, and ensure good user experience.

The client 101 may be an electronic device having a plurality of network connections and multimedia processing capabilities, such as a smart phone, a tablet computer, a video camera, a local personal computer (PC), a laptop, a desktop computer, etc. The device is connected to the CDN through the network, and participating in uploading and receiving the live streaming content. The server 102 may be a cloud server, a server cluster, a virtual server, etc. By means of the server, the CDN can provide an efficient and reliable content distribution service, thereby ensuring that good user experience can be provided under various network conditions.

It should be noted that, physical devices involved in the foregoing description are all exemplary in the figure, and do not represent the only ones. The present disclosure does not limit the specific form and type of the involved physical devices.

The technical solution of the present disclosure and how to solve the above technical problem with the technical solution of the present disclosure will be described in detail below with reference to specific embodiments. The following several specific embodiments may be combined with each other, and the same or similar concepts or processes may not be repeated in certain embodiments. Embodiments of the present disclosure will be described below with reference to the accompanying drawings.

The following introduces a specific implementation solution of a disaster recovery processing method for CDN live streaming provided by the present disclosure.

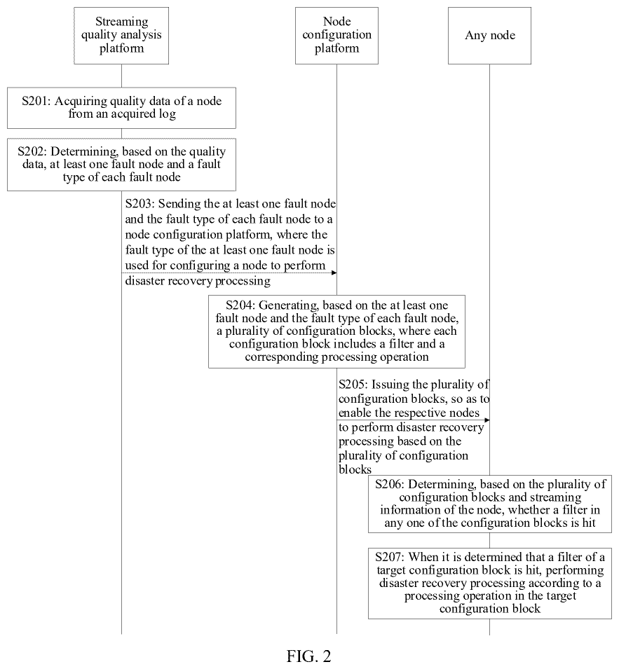

FIG. 2 is a schematic flowchart of a disaster recovery processing method for CDN live streaming provided by a first embodiment of the present disclosure. As shown in FIG. 2, the disaster recovery processing method for CDN live streaming specifically includes the following content.

S201: Acquiring quality data of a node from an acquired log.

In this step, nodes in CDN architecture include an edge node and a central node. The edge node is deployed on a server at edge of the network, which is close to a user, so as to reduce delay and improve response speed. It is responsible for processing a user request, and provides a fast content distribution and processing capability. The central node is deployed on a server at core of the network. It is responsible for managing and coordinating content distribution and data synchronization among a plurality of edge nodes. It has stronger computation and storage capabilities, and is used for processing large-scale data and complex content management tasks. A system log is a key data source for evaluating and monitoring a quality of a respective node. Generally, it includes various types of data, including a timestamp, a node identifier, user request information, streaming media information, error and warning information, a bandwidth utilization, a cache hit rate, connection information, and the like.

Specifically, a streaming quality analysis platform acquires quality data of a node from the system log. The quality data of edge nodes includes: streaming quality of a push streaming, streaming quality of a pull streaming, streaming quality of a relay streaming, a success rate of a pull-pull streaming, the number of a push-pull streaming, and an accumulation percentage of node logs for a respective edge node. The quality data of central nodes includes: streaming quality of a push streaming, streaming quality of a pull streaming, streaming quality of a relay streaming, a success rate of a push-pull streaming, the number of a push-pull streaming, and an outbound-inbound bandwidth ratio for respective central nodes. Where, the push streaming refers to a process in which the user uploads video or audio content from a device to a server, that is, a process of content uploading. The pull streaming refers to a process in which the user acquires the video or audio content from the server, that is, a process of content downloading.

The streaming quality of the push streaming refers to quality of streaming media content uploaded by the user from the client to the edge node or the central node. It includes indicators such as a definition, a bit rate, a frame rate of a video or audio, etc. The streaming quality of the pull streaming refers to quality of streaming media content transmitted from the edge node or the central node to the client. It also relates to the indicators such as the definition, the bit rate, the frame rate of the video or audio, etc. The streaming quality of the relay streaming refers to quality of streaming media content that the edge node or the central node forwards the content to other nodes or clients after receiving the push streaming. The success rate of the push-pull streaming refers to a ratio of the number of successful push streaming operations and pull streaming operations to a total number of attempts. The number of push-pull streaming refers to a total number of push streaming requests and pull streaming requests processed by the edge node or the central node within a specific time period. The accumulation percentage of node logs of the edge node refers to a percentage of a data amount of logs generated at the edge node relative to a storage capacity of logs of the edge node, and a high accumulation percentage indicates that an outbound speed of the network node is limited. The outbound-inbound bandwidth ratio of the central node refers to a usage ratio of an outbound bandwidth to an inbound bandwidth during a data transmission process of the central node, and a high outbound bandwidth ratio indicates that the central node mainly performs data reception and aggregation. By monitoring and analyzing the described quality data, the streaming quality analysis platform can identify potential performance bottlenecks and problems, optimize the configuration and operations of the edge node, and improve the quality of an overall streaming media service and the user experience.

S202: Determining, based on the quality data, at least one fault node and a fault type of each fault node.

In this step, the fault type includes speed limiting of an edge node, an outbound-inbound fault of a central node, and a full bandwidth utilization of the central node. The speed limiting of the edge node refers to the uploading or downloading speed of the edge node is limited due to a network strategy or hardware limitation, it would directly affect the quality of push streaming and pull streaming, resulting in a decrease in a bit rate of a video or audio streaming, and affecting the viewing experience of the user. The outbound-inbound fault of the central node refers to an abnormal transmission of an outbound or inbound traffic caused by a network connection problem, a hardware fault or a software configuration error during the data transmission process of the central node. The outbound fault would cause that the video or audio content cannot be effectively distributed from the central node to the edge node or the client. The inbound fault would cause that the central node cannot receive data from a content source or other nodes. The full bandwidth utilization of the central node refers to that available bandwidth of the central node is fully occupied, resulting in that an additional traffic request cannot be processed, which generally occurs during a traffic peak period or when the node configuration is inappropriate, resulting in delay in data transmission, an increase in packet loss rate and a decrease in overall performance.

As described in S201, the system log is the key data source for evaluating and monitoring the quality of the respective nodes, and includes various types of data based on live streaming historical data, including the timestamp, the node identifier, the user request information, the streaming media information, the error and warning information, the bandwidth utilization, the cache hit rate, the connection information, and the like. This provides a basis for constructing a fault identification model. Firstly, an initial fault identification model is constructed based on a neural network model. Then, quality data and fault conditions of a plurality of central nodes and a plurality of edge nodes are acquired according to historical live streaming data, so as to obtain a sample set. The sample set includes a plurality of samples, where each sample includes quality data of a node and whether there is a fault, and the sample further includes a fault type when there is a fault in the node. For example, an exemplary sample is acquired, and for the edge node, the streaming quality of the push streaming is 60%, the streaming quality of the pull streaming is 65%, the streaming quality of the relay streaming is 70%, the success rate of the push-pull streaming is 80%, the number of the push-pull streaming is 500, the accumulation percentage of the node logs is 30%, there is a fault and the fault type is speed limiting of the edge node. As can be seen from this exemplary sample, the uploading and downloading speeds of the video or audio content are affected due to the speed limiting of the edge node, resulting in more transmission failures and data processing backlogs. According to the sample set composed of such exemplary samples, the initial fault identification model is trained to obtain the fault identification model. By means of the fault identification model, the streaming quality analysis platform can automatically acquire relevant information about a node having a fault, thereby improving the automation and intelligent level of the streaming quality analysis platform.

Specifically, on the one hand, the quality data of the edge nodes and the central nodes described in S201 are input into a pre-acquired fault identification model for fault identification, so as to obtain the at least one fault node and the type of each fault node in the CDN live streaming. It can be understood that, the fault identification model is a model obtained by training based on historical data of live streaming nodes and used for identifying a fault of the node.

On the other hand, the at least one fault node and the fault type of each fault node are determined based on the quality data and threshold ranges of the quality data for different types of nodes under different types of faults. Specifically, based on the live streaming historical data, the threshold ranges of the quality data under different types of node faults are determined. The determination of the threshold ranges is based on various factors such as user experience, network performance standards, service quality requirements, historical fault records, and service requirements, etc. It is necessary to ensure high-quality user experience, and satisfy technical and service requirements. For example, for the edge node, if the streaming quality of the push streaming is lower than 70%, the streaming quality of the pull streaming is lower than 70%, the streaming quality of the relay streaming is lower than 75%, the success rate of the push-pull streaming is lower than 85%, and the accumulation percentage of the node logs is higher than 25%, then it is determined that the edge node may have a fault of the speed limiting of the edge node.

By automatically analyzing the quality data of the respective nodes, the streaming quality analysis platform can rapidly identify a fault node and a specific type thereof. The requirements of manual intervention and the investigation time are reduced. Not only the efficiency of fault detection is improved, but also the accuracy of diagnosis is enhanced, the risk of false positives and false negatives is reduced. Accumulated fault data can also be used for further analysis and optimization of the network architecture and service strategy, thereby driving continuous improvements.

S203: Sending the at least one fault node and the fault type of each fault node to a node configuration platform, where the fault type of the at least one fault node is used for configuring a node to perform disaster recovery processing.

For the node configuration platform side, the at least one fault node and the fault type of each fault node are acquired, that is, the at least one fault node and the fault type of each fault node sent by the streaming quality analysis platform are received.

Specifically, after detecting a fault node, the streaming quality analysis platform packs the at least one fault node and the fault type of each fault node into a data packet, sends the data packet to the node configuration platform by using standard protocols, such as hypertext transfer protocol (Hypertext Transfer Protocol, HTTP), hypertext transfer protocol secure (Hypertext Transfer Protocol Secure, HTTPS), message queue telemetry transport protocol (MQ Telemetry Transport, MQTT), and the like. The node configuration platform receives and analyzes the content of the data packet through monitoring a predetermined network port or an application programming interface (Application Programming Interface, API), and executes corresponding configuration and disaster recovery processing strategy according to the fault type, so as to ensure quick and reliable information transmission, and enable the node configuration platform to respond to a fault in time and quickly.

S204: Generating, based on the at least one fault node and the fault type of each fault node, a plurality of configuration blocks, where each configuration block includes a filter and a corresponding processing operation.

In this step, a configuration block is a logical unit for managing and processing a fault node. Each configuration block includes a filter and a corresponding processing operation, for identifying and processing a fault of a specific type. The filter plays a role of screening and identifying in the configuration block. The processing operation is a specific measure executed through a node of the filter. These measures may include rerouting the traffic, switching to a backup node, adjusting resource allocation, or performing other disaster recovery strategies.

Specifically, the node configuration platform generates the plurality of configuration blocks based on the at least one fault node, the fault type of each fault node, and preconfigured filtering rules and processing operations for different fault types. For example, a fault type identified by a filtering rule of a filter in configuration block 1 is speed limiting of the edge node, which is specifically characterized by: for the edge node, the streaming quality of the push streaming is lower than 70%, the streaming quality of the pull streaming is lower than 70%, the streaming quality of the relay streaming is lower than 75%, the success rate of the push-pull streaming is lower than 85%, the accumulation percentage of node logs is higher than 25%, and the corresponding processing operation is to switch to a backup node. A fault type identified by a filter identifying rule of a filter in configuration block 2 is a full bandwidth utilization of the central node, which is specifically characterized by: for the central node, the streaming quality of the push streaming is lower than 70%, the streaming quality of the pull streaming is lower than 70%, and the streaming quality of the relay streaming is lower than 75%, the success rate of push-pull streaming is lower than 85%, the number of the push-pull streaming abnormally increases, and the outbound-inbound bandwidth ratio is close to or up to 100%, the corresponding processing operation is to dynamically adjust the traffic routing, and allocate some traffic to other central nodes without full load. By generating these configuration blocks, the node configuration platform can automatically apply appropriate measures to solve different fault types, ensuring the stability and service quality of the network.

S205: Issuing the plurality of configuration blocks, so as to enable the respective nodes to perform disaster recovery processing based on the plurality of configuration blocks.

For any node side, the plurality of configuration blocks are acquired. The plurality of configuration blocks are obtained based on configuration of a fault node and a fault type, and each configuration block includes a filter and a corresponding processing operation.

In this step, the node configuration platform writes the generated plurality of configuration blocks into the platform, so that the respective nodes perform disaster recovery processing based on the plurality of configuration blocks.

The node configuration platform communicates with the platform through an API interface or a configuration management tool. After being generated, the configuration blocks are serialized into a standardized data format, such as JSON or XML, which facilitates transmission and analysis. Next, the platform sends the serialized configuration block data to a specified API endpoint of the platform through an HTTP POST request or other protocols. After receiving the configuration block data, the platform analyzes and verifies the data to ensure a correct format and complete content. If the verification is passed, the platform will store these configuration blocks into its internal configuration database or configuration management system. Once the configuration blocks are successfully written, the platform will update its configuration state so that relevant nodes can get the latest configuration for application. The node identifies a current fault type according to the filtering rule in the configuration block, and performs the corresponding processing operation, for example, switching to a backup node, adjusting traffic routing, or optimizing resource allocation. By means of this process, the whole network can quickly implement automated disaster recovery processing, and ensure that the service quality can be quickly restored and maintained when a fault occurs. This not only improves the flexibility and reliability of the network, but also reduces the requirements for manual intervention, thereby improving the overall operation efficiency.

S206: Determining, based on the plurality of configuration blocks and streaming information of the node, whether a filter in any one of the configuration blocks is hit.

In this step, the streaming information of the node refers to real-time data collected from the edge node or the central node, includes the streaming quality of the push streaming, the streaming quality of the pull streaming, the streaming quality of the relay streaming, the success rate of the push-pull streaming, the number of the push-pull streaming, a bandwidth utilization, and the like, and is used for indicating a current state and performance of the node.

Specifically, after the node configuration platform writes the plurality of generated configuration blocks into the platform, any node performs a comparison based on the plurality of configuration blocks and the current streaming information of the node, and determines whether the streaming information of the node satisfies a condition of a filter. If the streaming information of a certain node satisfies a condition of one or more filters, then it is considered that the node hits the corresponding configuration block. If the streaming information of the certain node does not satisfy a condition of any filter, it is considered that the node does not hit any configuration block. In this scenario, the node is considered to be in a normal operation state, no fault or abnormality requiring intervention is detected, no disaster recovery strategy is executed, and the node continues to operate according to its current configuration and operation state. By means of the process, any node can automatically identify and respond to a fault in the network, so as to perform intervention in time, thereby ensuring the continuity and quality of the live streaming service.

S207: When it is determined that a filter of a target configuration block is hit, performing disaster recovery processing according to a processing operation in the target configuration block.

In this step, the disaster recovery processing refers to a series of strategies and measures taken in the field of information technologies or data management, and the like, in order to cope with a sudden event (such as a natural disaster, a hardware fault, a network attack, etc.) that may cause system interruption or data loss, and ensure availability, integrity, and continuity of the system and data, so as to reduce the influence of a disaster on the service operation, and ensure the system to recover quickly after the disaster occurs.

In a specific implementation of the present disclosure, if the streaming information of a certain node satisfies a condition of one or more filters, it is determined that the node hits a filter of a corresponding configuration block, and it is determined that the filter is a filter of the target configuration block. Firstly, a target duration is randomly generated. After the target duration, the disaster recovery processing is performed according to the processing operation in the target configuration block. The target time duration may vary from a few seconds to a few minutes, depending on specific requirements, load conditions and the requirements of the service continuity of the system. By introducing random delay, simultaneous disaster recovery processing of all fault nodes can be avoided, thereby preventing a secondary impact on the system caused by an instantaneous load proliferation, helping to balance the load of the system, reducing resource competition and conflict, and improving the overall stability of the system.

Specifically, a first scenario is that: if streaming information of a certain central node satisfies a condition of one or more filters, it is determined that the central node hits a filter of a corresponding configuration block, it is determined that the filter is a filter of the target configuration block, and disaster recovery processing is performed according to a processing operation in the target configuration block. When a serious fault occurs in the central node or the central node is completely unavailable, in order to ensure the continuity and stability of the service, all the traffic is transferred to other nodes which normally operate, i.e., the central node is disabled, and all push streaming and all pull streaming at the central node are switched to other non-fault central nodes. When the load of the central node is too high or the bandwidth is nearly saturated, in order to effectively relieve the pressure of the node, and at the same time maintain a part of functional operations of the node, so as to avoid an excessive adjustment burden on the system, then only a part of traffic is transferred, i.e., the central node is disabled, and a part of existing push streaming at the central node is switched to other non-fault central nodes.

A second scenario is that: if streaming information of a certain edge node satisfies a condition of one or more filters, it is determined that the edge node hits a filter of a corresponding configuration block, it is determined that the filter is a filter of the target configuration block, and disaster recovery processing is performed according to a processing operation in the target configuration block. The fault type of the edge node is speed limiting of the edge node, so the corresponding disaster recovery processing measure is to relay a push streaming and/or a pull streaming at the edge node to other edge nodes in the same area as the edge node and have no speed limiting. Geographically closer edge nodes in the same area mean shorter network paths and faster response times, meanwhile, the edge nodes in the same area are in the same network topology structure, have similar network conditions and service capabilities, therefore, selecting the edge nodes in the same area can significantly reduce the network delay, and ensure that the user does not experience obvious delay or interruption due to the speed limiting of the node when accessing the CDN live streaming content. The network delay and bandwidth consumption are reduced to the maximum extent, the efficiency and stability of the service are maintained, and changes in network conditions are dynamically adapted without affecting user experience.

According to the disaster recovery processing method for CDN live streaming provided by the embodiments of the present disclosure, quality data of a node is acquired from a system log, a fault node and a fault type thereof are identified, and automated disaster recovery processing is performed based on configuration blocks generated based on the fault node and the fault type. By means of automatically identifying and responding to the fault, the disaster recovery processing method for CDN live streaming improves the efficiency and accuracy of fault detection, reduces manual intervention and investigation time, ensures the continuity of the user experience and the high efficiency of the service, enhances the flexibility and reliability of the CDN system, optimizes the resource allocation, and improves the quality of live streaming service and the user experience.

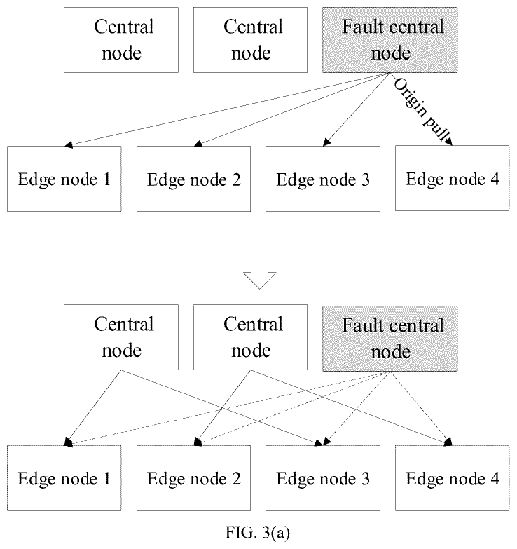

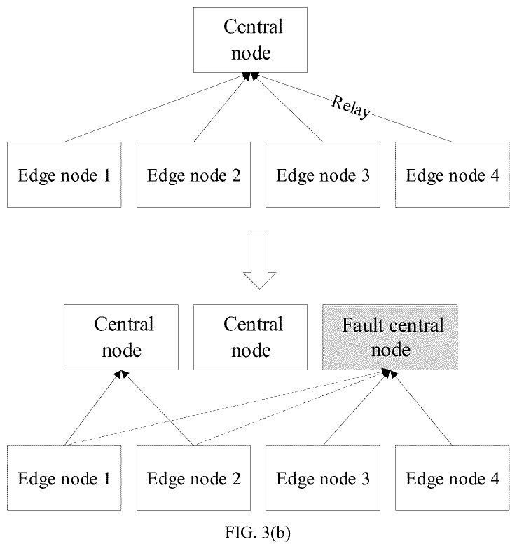

FIG. 3(a) is a schematic diagram of a specific implementation of a disaster recovery processing method for CDN live streaming provided by a second embodiment of the present disclosure. FIG. 3(b) is a schematic diagram of another specific implementation of the disaster recovery processing method for CDN live streaming provided by the second embodiment of the present disclosure. On the basis of the foregoing embodiments, if streaming information of a certain central node satisfies a condition of one or more filters, it is determined that the central node hits a filter of a corresponding configuration block, and it is determined that the filter is a filter of a target configuration block. The disaster recovery processing is performed according to a processing operation in the target configuration block. Specifically, it includes the following scenarios.

In a first scenario, as shown in FIG. 3(a), when the central node has a serious fault or completely loses functions, that is, when an outbound-inbound fault of the central node occurs, in order to ensure the continuity and stability of the service, then all the traffic is re-routed to other nodes in normal operations, that is, the central node is disabled, and all the push streaming and all the pull streaming at the central node are switched to the other non-fault central nodes.

In a second scenario, as shown in FIG. 3(b), when the load of the central node is excessively high or the bandwidth is nearly saturated, that is, the bandwidth utilization of the central node is full, in order to effectively relieve the pressure of the node, and at the same time maintain a part of functional operations of the node, so as to avoid an excessive adjustment burden on the system, then only a part of traffic is transferred, that is, the central node is disabled, and a part of existing push streaming at the central node is switched to the other non-fault central nodes.

By means of the disaster recovery processing method corresponding to the fault of the central node, the flexibility and reliability of the system are significantly improved, the resource allocation is optimized, and the service quality and user experience under different fault conditions are ensured.

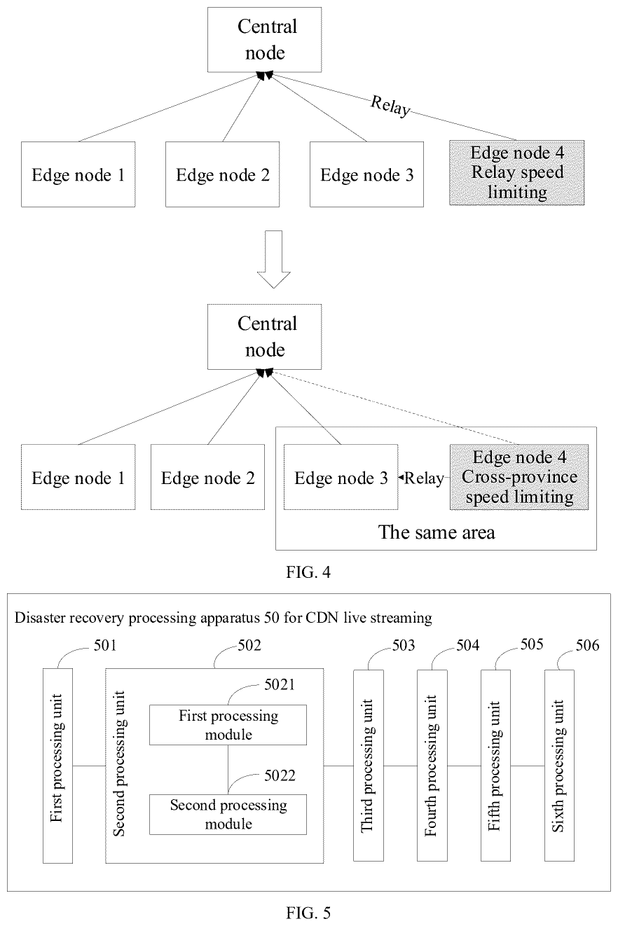

FIG. 4 is a schematic diagram of a specific implementation of a disaster recovery processing method for CDN live streaming provided by a third embodiment of the present disclosure. As shown in FIG. 4, based on the foregoing embodiments, if streaming information of a certain edge node satisfies a condition of one or more filters, it is determined that the edge node hits a filter of a corresponding configuration block, and it is determined that the filter is a filter of a target configuration block. The disaster recovery processing is performed according to a processing operation in the target configuration block. Specifically, it includes the following content.

As shown in FIG. 4, when a fault occurs at the edge node, i.e., when the speed limiting of the edge node occurs, in order to ensure that the user does not experience obvious delay or interruption due to the speed limiting of the node when accessing the CDN live streaming content, the corresponding disaster recovery processing mode is to relay a push streaming and/or a pull streaming at the edge node to other edge nodes that are in the same area as the edge node and have no speed limiting.

By means of the disaster recovery processing method corresponding to the fault of the edge node, it can be effectively ensured that the user does not experience obvious delay or interruption when accessing the CDN live streaming content. Secondly, since the edge nodes in the same area are selected, the bandwidth consumption is reduced, and area load balancing in the same area is achieved. This avoids a situation that a certain edge node is overloaded while other node resources are idle, thereby improving the reliability of the overall service and user experience.

FIG. 5 is a schematic structural diagram of a disaster recovery processing apparatus for CDN live streaming provided by a first embodiment of the present disclosure. It is applied to a streaming quality analysis platform, as shown in FIG. 5, the disaster recovery processing apparatus 50 for CDN live streaming includes:
a first processing unit 501, configured to acquire quality data of a node from an acquired log;
a second processing unit 502, configured to determine, based on the quality data, at least one fault node and a fault type of each fault node;
a third processing unit 503, configured to send the at least one fault node and the fault type of each fault node to a node configuration platform, where the fault type of the at least one fault node is used for configuring the node to perform disaster recovery processing.

In a possible implementation, the second processing unit 502 includes:
a first processing module 5021, configured to input the quality data into a pre-acquired fault identification model for fault identification, so as to obtain the at least one fault node and the fault type of each fault node;
where the fault identification model is a model obtained by training based on historical data of live streaming nodes and used for identifying a fault of the node;
a second processing module 5022, configured to determine, based on the quality data and threshold ranges of the quality data for different types of nodes under different types of faults, the at least one fault node and the fault type of each fault node.

In a possible implementation, the disaster recovery processing apparatus 50 for CDN live streaming further includes:
a fourth processing unit 504, configured to construct an initial fault identification model based on a neural network model;
a fifth processing unit 505, configured to acquire quality data and fault conditions of a plurality of central nodes and a plurality of edge nodes according to live streaming historical data, so as to obtain a sample set, where the sample set includes a plurality of samples, each sample includes quality data of a node and whether there is a fault, and the sample further includes a fault type when there is a fault in the node; and
a sixth processing unit 506, configured to train the initial fault identification model according to the sample set to obtain the fault identification model.

In a possible implementation, the above quality data includes: streaming quality of a push streaming, streaming quality of a pull streaming, streaming quality of a relay streaming, a success rate of a push-pull streaming, the number of a push-pull streaming, and an accumulation percentage of node logs for respective edge nodes; streaming quality of a push streaming, streaming quality of a pull streaming, streaming quality of a relay streaming, a success rate of a push-pull streaming, the number of a push-pull streaming, and an outbound-inbound bandwidth ratio for respective central nodes.

In a possible implementation, the above fault type includes: speed limiting of an edge node, an outbound-inbound fault of a central node, and a full bandwidth utilization of the central node.

The disaster recovery processing apparatus for CDN live streaming provided by the embodiments of the present disclosure can execute the method provided by the described method embodiments, and the implementation principle and technical effect thereof are similar, which are not repeated here.

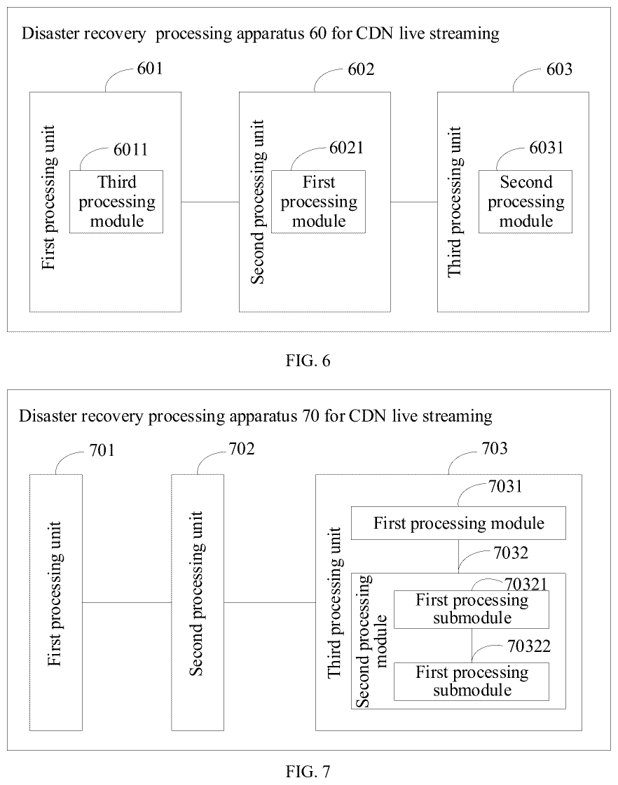

FIG. 6 is a schematic structural diagram of a disaster recovery processing apparatus for CDN live streaming provided by a second embodiment of the present disclosure. It is applied to a node configuration platform, as shown in FIG. 6, the disaster recovery processing apparatus 60 for CDN live streaming includes:
a first processing unit 601, configured to acquire at least one fault node and a fault type of each fault node;
a second processing unit 602, configured to generate based on the at least one fault node and the fault type of each fault node, a plurality of configuration blocks, where each configuration block comprises a filter and a corresponding processing operation;
a third processing unit 603, configured to issue the plurality of configuration blocks, so as to enable respective nodes to perform disaster recovery processing based on the plurality of configuration blocks.

In a possible implementation, the second processing unit 602 includes:
a first processing module 6021, configured to generate the plurality of configuration blocks based on the at least one fault node, the fault type of each fault node, and preconfigured filtering rules and processing operations for different fault types of different nodes.

In a possible implementation, the third processing unit 603 includes:
a second processing module 6031, configured to write the plurality of configuration blocks into a platform.

In a possible implementation, the first processing unit 601 includes:
a third processing module 6011, configured to receive at least one fault node and the fault type of each fault node that are sent by a streaming quality analysis platform.

In a possible implementation, the above fault type includes: speed limiting of an edge node, an outbound-inbound fault of a central node, and a full bandwidth utilization of the central node.

The disaster recovery processing apparatus for CDN live streaming provided by the embodiments of the present disclosure can execute the method provided by the described method embodiments, and the implementation principle and technical effect thereof are similar, which are not repeated here.

FIG. 7 is a schematic structural diagram of a disaster recovery processing apparatus for CDN live streaming according to a third embodiment of the present disclosure. It is applied to a node, as shown in FIG. 7, the disaster recovery processing apparatus 70 for CDN live streaming includes:
a first processing unit 701, configured to acquire a plurality of configuration blocks, where the plurality of configuration blocks are obtained based on configuration of a fault node and a fault type, and each configuration block comprises a filter and a corresponding processing operation;
a second processing unit 702, configured to determine, based on the plurality of configuration blocks and streaming information of a node, whether a filter in any one of the configuration blocks is hit;
a third processing unit 703, configured to when it is determined that a filter of a target configuration block is hit, perform disaster recovery processing according to a processing operation in the target configuration block.

In a possible implementation, the third processing unit 703 includes:
a first processing module 7031, configured to randomly generate a target duration; and
a second processing module 7032, configured to after the target duration, perform the disaster recovery processing according to the processing operation in the target configuration block.

In a possible implementation, the second processing module 7032 includes:
a first processing submodule 70321, configured to disable the central node, and switch all push streaming and all pull streaming at the central node to other non-fault central nodes; or,
disable the central node, and switch a part of existing push streaming at the central node to other non-fault central nodes;
a first processing submodule 70322, configured to relay a push streaming and/or a pull streaming at the edge node to other edge nodes that are in the same area as the edge node and have no speed limiting.

The disaster recovery processing apparatus for CDN live streaming provided by the embodiments of the present disclosure can execute the method provided by the described method embodiments, and the implementation principle and technical effect thereof are similar, which are not repeated here.

According to the embodiments of the present disclosure, the present disclosure further provides an electronic device and a readable storage medium.

According to the embodiments of the present disclosure, the present disclosure provides a non-transitory computer-readable storage medium storing computer instructions, where the computer instructions are used for enabling a computer to execute the solution according to the foregoing method embodiments.

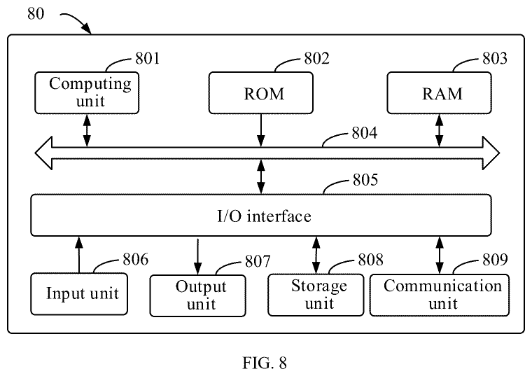

FIG. 8 is a schematic structural diagram of an electronic device for implementing a disaster recovery processing method for CDN live streaming according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device can also represent various forms of mobile apparatuses, such as personal digital processing, a cellular telephone, a smart phone, a wearable device, and other similar computing apparatuses. The components, their connections and relationships, and their functions shown herein are only exemplary, which are not intended to limit implementations of the present disclosure described and/or requested herein.

As shown in FIG. 8, the device 80 includes a computing unit 801 that can perform various appropriate actions and processes according to a computer program stored in a read-only memory (ROM) 802 or a computer program loaded from a storage unit 808 into a random access memory (RAM) 803. In the RAM 803, various programs and data necessary for the operations of the device 80 are also stored. The computing unit 801, the ROM 802, and the RAM 803 are connected to each other through a bus 804. An input/output (I/O) interface 805 is also connected to the bus 804.

A plurality of components in the device 80 are connected to the I/O interface 805, including: an input unit 806, such as a keyboard, a mouse, and the like; an output unit 807, such as various types of displays, speakers, and the like; a storage unit 808, such as a magnetic disk, an optical disk, and the like; and a communication unit 809 such as a network card, a modem, a wireless communication transceiver, and the like. The communication unit 809 allows the device 80 to exchange information/data with other devices through a computer network such as the Internet and/or various telecommunication networks.

The computing unit 801 can be a variety of general-purpose and/or special-purpose processing components with processing and computing capabilities. Some examples of the computing unit 801 include, but are not limited to, a central processing unit (CPU), a graphics processing unit (GPU), various specific artificial intelligence (Artificial Intelligence, AI) computing chips, various computing units running machine learning model algorithms, a digital signal processor (DSP), and any suitable processors, controllers, microcontrollers, etc. The computing unit 801 executes the various methods and processes described above, such as a disaster recovery processing method. For example, in some embodiments, the disaster recovery processing method can be implemented as a computer software program tangibly embodied on a machine-readable medium, such as the storage unit 808. In some embodiments, a part or all of the computer program may be loaded into and/or installed onto the device 80 via the ROM 802 and/or the communication unit 809. When the computer program is loaded into the RAM 803 and executed by the computing unit 801, one or more steps of the disaster recovery processing method described above can be executed. Alternatively, in other embodiments, the computing unit 801 can be configured to perform the disaster recovery processing method by any other suitable means, such as by means of firmware.

Various implementations of the systems and techniques described above in the present article can be implemented in digital electronic circuitry, integrated circuitry, a field programmable gate array (FPGA), an application specific integrated circuit (ASIC), application specific standard parts (ASSP), a system on chip (SOC), a complex programmable logic device (CPLD), a computer hardware, a firmware, a software, and/or combinations thereof. These various implementations may include being implemented in one or more computer programs that are executable and/or interpretable on a programmable system including at least one programmable processor. The programmable processor may be a special-purpose or a general-purpose programmable processor, and may receive data and instructions from a storage system, at least one input apparatus, and at least one output apparatus, and transmit data and instructions to the storage system, the at least one input apparatus, and the at least one output apparatus.

Program codes for implementing the method of the present disclosure may be written in any combination of one or more programming languages. The program codes may be provided to a processor or controller of a general-purpose computer, a special-purpose computer, or other programmable data processing apparatuses, such that the program codes, when executed by the processor or controller, causes the functions/operations specified in the flowcharts and/or block diagrams to be performed. The program codes may be executed entirely on a machine, partly on the machine, as an independent software package partly on the machine and partly on a remote machine, or entirely on the remote machine or server.

In the context of the present disclosure, a machine-readable medium may be tangible media that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage media would include an electrical connection based on one or more wires, a portable computer diskette, a hard disk, a random access memory (RAM), a read-only memory (ROM), an erasable programmable read-only memory (EPROM) or a flash memory, an optical fiber, a compact disc read-only memory (CD-ROM), an optical storage device, a magnetic storage device, or any suitable combination of the foregoing.

To provide the interaction with a user, the systems and techniques described herein can be implemented on a computer, and the computer has: a display apparatus for displaying information to the user, e.g., a cathode ray tube (CRT), or a liquid crystal display (LCD) monitor; and a keyboard and a pointing apparatus, e.g., a mouse or a trackball. The user can provide input to the computer through the keyboard and the pointing apparatus. Other kinds of apparatuses may also be used to provide the interaction with the user. For example, feedback provided to the user may be any form of sensory feedback (e.g., visual feedback, auditory feedback, or tactile feedback); and the input from the user may be received in any form, including acoustic input, speech input, or tactile input.

The systems and techniques described herein may be implemented in a computing system that includes backend components (e.g., as a data server), or in a computing system that includes middleware components (e.g., an application server), or in a computing system that includes frontend components (e.g., a user computer having a graphical user interface or a web browser, the user may interact with the implementations of the systems and techniques described herein through the graphical user interface or the web browser), or in a computing system that includes any combination of the backend, middleware, or frontend components. The components of the system may be interconnected by any form or medium of digital data communication (e.g., communication networks). Examples of the communication networks include a local area network (LAN), a wide area network (WAN), and the Internet.

A computer system may include clients and servers. The clients and servers are generally remote from each other and typically interact through a communication network. The client and server relationships are generated by computer programs running on the respective computers and having a client-server relationship therebetween. The server may be a cloud server, also referred to as a cloud computing server or a cloud host, and is a host product in a cloud computing service system, so as to solve the defects of management difficulty and poor service extensibility in a traditional physical host and a virtual private server (VPS). The server may also be a server of a distributed system, or a server combined with a block chain.

It should be understood that the steps may be reordered, added, or deleted using the various forms of flows described above. For example, the respective steps described in the present disclosure may be executed in parallel, may be executed sequentially, or may be executed in a different order, as long as desired results of the technical solutions disclosed in the present disclosure can be achieved, which are not limited herein.

The above specific implementations do not constitute a limitation to protection scope of the present disclosure. It should be understood by a person skilled in the art that various modifications, combinations, sub-combinations and replacements can be made according to design requirements and other factors. Any modifications, equivalent replacements, improvements and the like made within the spirit and principle of the present disclosure shall fall within the protection scope of the present disclosure.

What is claimed is:

1. A disaster recovery processing method for content delivery network (CDN) live streaming, comprising:
acquiring quality data of a node from an acquired log;
determining, based on the quality data, at least one fault node and a fault type of each fault node; and
sending the at least one fault node and the fault type of each fault node to a node configuration platform, wherein the fault type of the at least one fault node is used for configuring the node to perform disaster recovery processing.

2. The method according to claim 1, wherein the determining, based on the quality data, the at least one fault node and the fault type of each fault node comprises:
inputting the quality data into a pre-acquired fault identification model for fault identification, so as to obtain the at least one fault node and the fault type of each fault node;
wherein the fault identification model is a model obtained by training based on historical data of live streaming nodes and used for identifying a fault of the node.

3. The method according to claim 1, wherein the determining, based on the quality data, the at least one fault node and the fault type of each fault node comprises:
determining, based on the quality data and threshold ranges of the quality data for different types of nodes under different types of faults, the at least one fault node and the fault type of each fault node.

4. The method according to claim 2, further comprising:
constructing an initial fault identification model based on a neural network model;
acquiring quality data and fault conditions of a plurality of central nodes and a plurality of edge nodes according to live streaming historical data, so as to obtain a sample set, wherein the sample set comprises a plurality of samples, each sample comprises quality data of a node and whether there is a fault, and the sample further comprises a fault type when there is a fault in the node; and
training the initial fault identification model according to the sample set to obtain the fault identification model.

5. The method according to claim 1, wherein the quality data comprises at least one of:
streaming quality of a push streaming, streaming quality of a pull streaming, streaming quality of a relay streaming, a success rate of a push-pull streaming, the number of a push-pull streaming, and an accumulation percentage of node logs for respective edge nodes;
streaming quality of a push streaming, streaming quality of a pull streaming, streaming quality of a relay streaming, a success rate of a push-pull streaming, the number of a push-pull streaming, and an outbound-inbound bandwidth ratio for respective central nodes.

6. The method according to claim 1, wherein the fault type comprises at least one of:
speed limiting of an edge node, an outbound-inbound fault of a central node, and a full bandwidth utilization of the central node.

7. A disaster recovery processing method for content delivery network (CDN) live streaming, comprising:
acquiring at least one fault node and a fault type of each fault node;
generating, based on the at least one fault node and the fault type of each fault node, a plurality of configuration blocks, wherein each configuration block comprises a filter and a corresponding processing operation; and
issuing the plurality of configuration blocks, so as to enable respective nodes to perform disaster recovery processing based on the plurality of configuration blocks.

8. The method according to claim 7, wherein the generating, based on the at least one fault node and the fault type of each fault node, the plurality of configuration blocks comprises:
generating the plurality of configuration blocks based on the at least one fault node, the fault type of each fault node, and preconfigured filtering rules and processing operations for different fault types of different nodes.

9. The method according to claim 7, wherein the issuing the plurality of configuration blocks comprises:
writing the plurality of configuration blocks into a platform.

10. The method according to claim 7, wherein the acquiring the at least one fault node and the fault type of each fault node comprises:
receiving at least one fault node and the fault type of each fault node that are sent by a streaming quality analysis platform.

11. The method according to claim 7, wherein the fault type comprises at least one of:
speed limiting of an edge node, an outbound-inbound fault of a central node, and a full bandwidth utilization of the central node.

12. A disaster recovery processing method for content delivery network (CDN) live streaming, applied to a node, comprising:
acquiring a plurality of configuration blocks, wherein the plurality of configuration blocks are obtained based on configuration of a fault node and a fault type, and each configuration block comprises a filter and a corresponding processing operation;
determining, based on the plurality of configuration blocks and streaming information of the node, whether a filter in any one of the configuration blocks is hit; and
when it is determined that a filter of a target configuration block is hit, performing disaster recovery processing according to a processing operation in the target configuration block.

13. The method according to claim 12, wherein the performing the disaster recovery processing according to the processing operation in the target configuration block comprises:
randomly generating a target duration; and
after the target duration, performing the disaster recovery processing according to the processing operation in the target configuration block.

14. The method according to claim 12, wherein when the node is a central node, the performing the disaster recovery processing according to the processing operation in the target configuration block comprises:
disabling the central node, and switching all push streaming and all pull streaming at the central node to other non-fault central nodes; or,
disabling the central node, and switching a part of existing push streaming at the central node to other non-fault central nodes.

15. The method according to claim 12, wherein when the node is an edge node, the performing the disaster recovery processing according to the processing operation in the target configuration block comprises:
relaying a push streaming or a pull streaming at the edge node to other edge nodes that are in the same area as the edge node and have no speed limiting.

16. The method according to claim 12, wherein when the node is an edge node, the performing the disaster recovery processing according to the processing operation in the target configuration block comprises:
relaying a push streaming and a pull streaming at the edge node to other edge nodes that are in the same area as the edge node and have no speed limiting.

17. An electronic device, comprising: a memory and a processor;
the memory is stored with computer executable instructions; and
the processor executes the computer executable instructions stored in the memory, so as to enable the processor to execute the method according to claim 1.

18. An electronic device, comprising: a memory and a processor;
the memory is stored with computer executable instructions; and
the processor executes the computer executable instructions stored in the memory, so as to enable the processor to execute the method according to claim 7.

19. An electronic device, comprising: a memory and a processor;
the memory is stored with computer executable instructions; and
the processor executes the computer executable instructions stored in the memory, so as to enable the processor to execute the method according to claim 12.

20. A non-transitory computer-readable storage medium storing computer instructions, wherein the computer instructions are used for enabling a computer to execute the method according to claim 1.
